(19) United States
(12) Patent Application Publication
(10) Pub. No.: US 2010/0228962 A1
(43) Pub. Date: Sep. 9, 2010

(54) OFFLOADING CRYPTOGRAPHIC PROTECTION PROCESSING

(75) Inventors: Daniel R. Simon, Kirkland, WA (US); Pascal Menezes, Bellevue, WA (US); Brian D. Swander, Kirkland, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 12/400,281

(22) Filed: Mar. 9, 2009

(51) Int. Cl. H04L 9/06

(52) U.S. Cl. 713/150; 380/278

(57) ABSTRACT

Some embodiments are directed to processing packet data sent according to a security protocol between a first computer and a second computer via a forwarding device. The forwarding device performs a portion of the processing, and forwards the packet data to a third computer, connected to the forwarding device, for other processing. The third computer may support non-standard extensions to the security protocol, such as extensions used in authorizing and establishing a connection over the secure protocol. The packet data may be subject to policies, such as firewall policies or security policies, that may be detected by the third computer. The third computer sends the results of its processing, such as a cryptographic key, or a detected access control policy, to the forwarding device.

### BACKGROUND

Security is an important aspect of communications between computers. One important part of security in inter-computer communications is access control. For example, a computer system may implement access control policies that specify what type of network traffic is allowed in the computer system. The policies may specify, for example, what types of network traffic are permitted to be sent to what servers from what clients.

Another important part of providing secure communication between networked computing devices is cryptographic protection. One type of cryptographic protection is encryption. Various communication protocols exist that employ encryption. One example is the Internet Protocol Security (IPsec) Protocol that may be used for secure communications over the Internet Protocol (IP) layer, and which employs both authentication and encryption. In IPsec, two computing devices may first authenticate each other and exchange information needed to establish an encrypted session. Then, each device may encrypt outgoing packets to the other device, and decrypt incoming packets from the other device. Transport Layer Security (TLS) and its predecessor, Secure Sockets Layer (SSL), are other examples of communication protocols that employ encryption.

Another type of cryptographic protection is integrity protection, which is used to protect data exchanged between networked computing devices from an intercepting computer attempting to tamper with the exchanged data. A sending computer performs integrity protection by including a tag (sometimes known as a signature, message authentication code or message integrity code) with the data that is computed using a keyed data integrity algorithm that relies on a secret key to be computed correctly for any particular data. The receiving computer has the correct key, and therefore is able to perform the same computation as the sender to integrity-verify that the data in question was sent by an entity in possession of the correct key. Both integrity protection and encryption may be performed on the same data, or integrity protection may be performed on data that is not also encrypted.

Some network interface cards (NICs), such as may be used to connect a computer to a computer network such as the Ethernet, may include dedicated hardware to perform cryptographic protection processing, such as encryption/decryption and/or integrity protection, in the NIC itself. A computer equipped with a NIC having cryptographic protection hardware support may offload cryptographic protection of network packets to the NIC. Offloading cryptographic protection-related tasks to a NIC is desirable in some scenarios, because it may reduce the processing burden on the CPU of the computer, enabling it to perform other tasks more efficiently.

### SUMMARY

Some computer systems may include a forwarding device, such as a switch, hub, or router, that performs security-related processing for network packets sent between two other computers according to a protocol such as TCP/IP, UDP, or HTTP. The network communications between the two other computers may be directed via the forwarding device, so that the forwarding device can process the packets before they reach the destination computer. In some instances, the processing performed by the forwarding device may involve encrypting or decrypting the packets, or blocking the packets from reaching the destination computer when an access control policy indicates that the connection over which the packets are sent should not be allowed.

While such forwarding devices are useful in that they reduce the burden of performing computationally-intensive security-related processing, such as encryption processing, on the communicating computers, such forwarding devices may also have limitations. For example, users of the communicating computers may wish to use non-standard (e.g., proprietary) security protocols that are not supported by the forwarding device. Additionally, while the forwarding device may be able to implement simple policies, such as those based on source and destination IP addresses and port numbers, it may not be able to implement more sophisticated access control policies that use other criteria.

According to some embodiments of the invention, a forwarding device may be coupled over a communications link with a gateway server, which may perform security-related processing in conjunction with the forwarding device. Upon receiving a network packet sent between two other computers, the forwarding device may at least partially process the packet, and in some cases (e.g., if the packet processing involves types of processing that the forwarding device does not support) the forwarding device may forward the packet to the gateway server for additional processing. The additional processing performed by the gateway server may include, for example, recognizing which access control policies are applicable to the packet, or establishing a secure connection using extensions to a security protocol that are not supported by the forwarding device. The gateway server may then communicate the results of its processing, such as a cryptographic key obtained during the connection establishment, or an applicable access control policy, to the forwarding device.

The foregoing is a non-limiting summary of examples of some disadvantages of prior devices and of some embodiments that address these disadvantages. It should be appreciated that the invention is not limited to these embodiments, nor is it limited to systems or processes that address all or some of the above-discussed disadvantages of the prior art. Rather, the invention is defined solely by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a prior art computer system in which communications from a client may be sent to a server through a forwarding device;

FIG. 2 is a diagram of a computer system in which some embodiments of the invention may be implemented;

FIG. 3A is a high-level flowchart of a process by which a forwarding device and a gateway server may jointly process network packets received by the forwarding device;

FIG. 3B is a flowchart of a process, according to some embodiments, by which a gateway server may process a packet forwarded by a forwarding device to recognize policies that apply to the packet;

FIG. 3C is a flowchart of a process, according to some embodiments, by which a gateway server may process a packet forwarded by a forwarding device according to extensions to a security protocol that are not supported by the forwarding device;

FIG. 4 is a detailed block diagram of a computer system for processing traffic sent according to the IPsec protocol, according to some embodiments;

FIG. 5 is a flowchart of a process, according to some embodiments, by which a gateway server and a forwarding device may jointly process incoming IKE/AuthIP packets received by the forwarding device;

FIG. 6 is a flowchart of a process, according to some embodiments of the invention, by which a gateway server and a forwarding device may jointly process incoming non-IKE/AuthIP packets, including both IPsec and non-IPsec (non-secure) packets, received by the forwarding device; and

FIG. 7 is a flowchart of a process by which a gateway server and a forwarding device may jointly process outgoing packets received by the forwarding device, according to some embodiments.

### DETAILED DESCRIPTION

Encryption processing is a computationally intensive task that can consume a significant portion of the processing resources of a computer. Accordingly, in order to reduce the processing burden of performing encryption-related tasks on computers that send and receive encrypted communications, some systems have dedicated computing devices for processing encryption traffic.

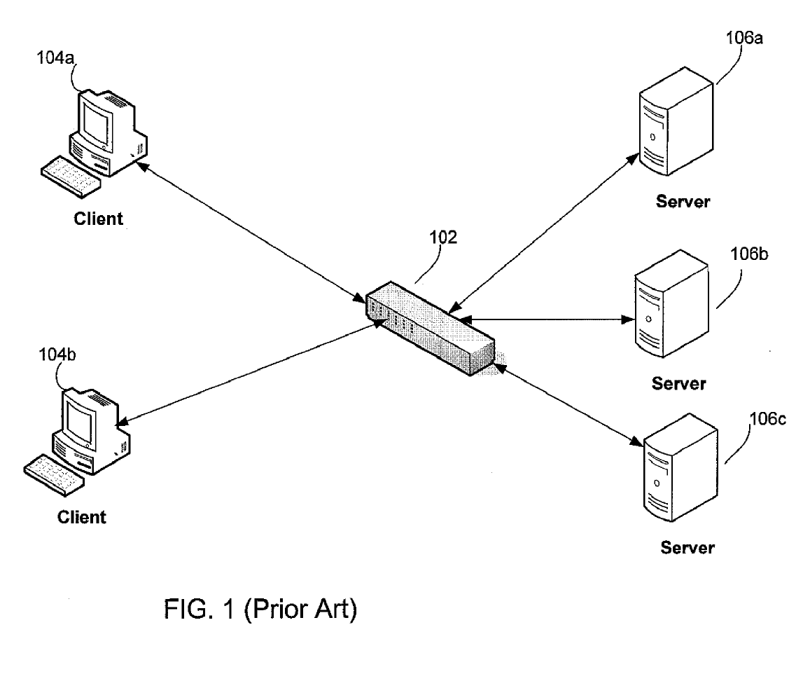

FIG. 1 is a diagram of a computer system that includes a switch 102, which may perform processing of security protocols, including encryption processing, for servers 106a, 106b, and 106c. In the example of FIG. 1, communications between the servers 106 and client computers 104a and 104b may be intended to be encrypted. Rather than having each of the servers 106 perform encryption-related tasks for the communications between itself and one of the clients 104, the switch performs these tasks for the servers.

The inventors have appreciated that while the use of a switch, such as switch 102, to perform processing according to a security protocol, which may include encryption processing, may have some benefits, such as reducing the processing burden of performing encryption-related tasks on other computers, it also has some limitations. By having their security-related tasks performed by the switch 102 rather than performing it themselves, the servers 106 and the clients 104 may not have the same range of security-related functionality available to them as if they perform all the security-related processing themselves, as the switch may have more limited support in certain areas. For example, a network administrator may desire to apply more elaborate policies, such as access control policies or firewall policies, on network traffic passing through the switch than the switch is capable of processing. As another example, the computers communicating using a particular security protocol may be configured to use extensions (e.g., proprietary extensions) to the protocol that are not part of the standard protocol, and that the switch does not support.

Accordingly, the inventors have appreciated that it may be useful to employ a computer, in conjunction with the switch, that performs a portion of the security-related processing that the switch does not support or for which advantages may be obtained by performing this processing in the computer.

The security-related processing may be divided between the computer and the switch in any suitable way. In some embodiments, once the computer has completed its portion of the security-related processing it may communicate the results of this processing to the switch, and the switch may use this information to perform its portion of the security-related processing. In some embodiments, the portion of the processing performed by the computer may not be as computationally expensive as the processing performed by the switch, because the switch may have dedicated hardware for performing its portion of the security-related processing.

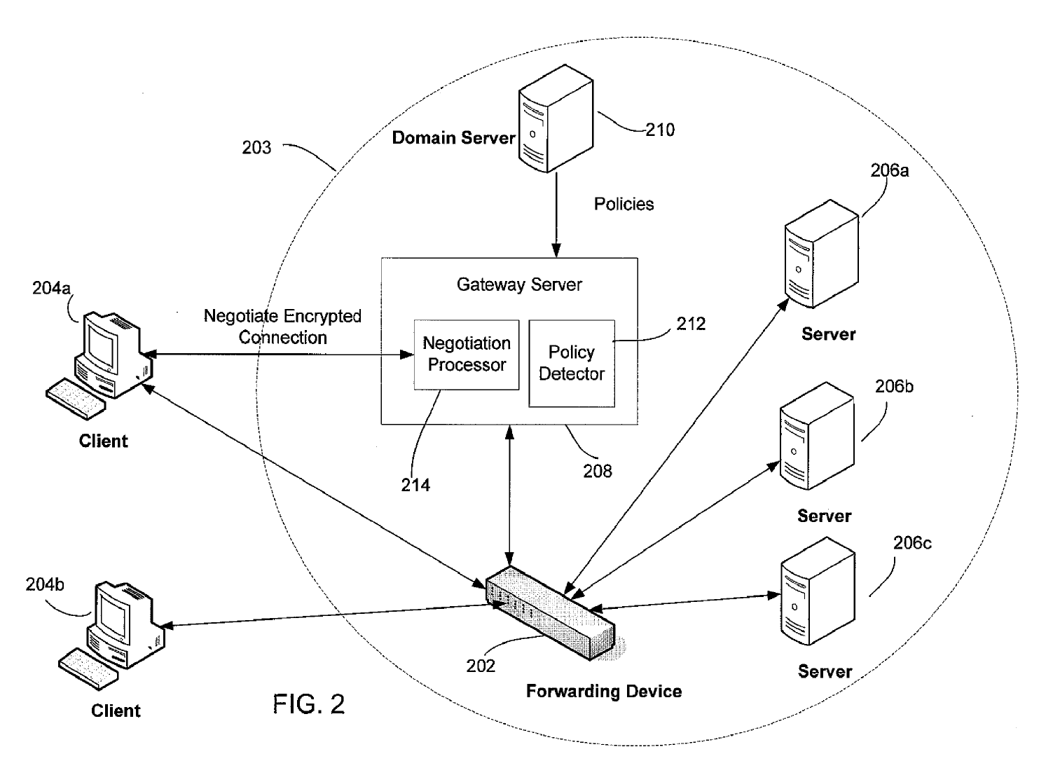

FIG. 2 is a diagram of a computer system in which some embodiments of the invention may be implemented. FIG. 2 includes one or more client computers 204a, 204b, and 204c that send communications to devices in a network 203. Client computers 204 may be any suitable type of computing devices capable of communicating over any suitable security protocol via a communication medium, such as a computer network. For example, client computers 204 may be laptop computers, desktop computers, mobile devices, smart phones, PDAs, any combination of any of these devices, or any other suitable type of computing device, as the invention is not limited in this respect. In some embodiments of the invention, client computers 204 may be computers loaded with one or more versions of the WINDOWS® operating system developed by the Microsoft® Corporation.

Network 203 comprises a domain server 210, a gateway server 208, a forwarding device 202, and servers 206a, 206b, and 206c. Server computers 206 may be any suitable computer servers, using any suitable computing architecture, as the invention is not limited in this respect. In some embodiments, server computers 206 may be configured with any suitable operating system, including one or more versions of the Windows® Server operating systems, such as, for example, the Windows® Server 2008 operating system developed by Microsoft® Corporation. Server computers 206 may provide any suitable computer services, such as email services, database services, data storage services, or any other suitable services as the invention is not limited in this respect. In the example illustrated by FIG. 2, communications between server computers 206 and client computers 204 may be encrypted (at least between forwarding device 202 and client computers 204) according to any suitable security protocol, including, for example, IPsec, SSL, or TLS.

Forwarding device 202 may forward network communications between client computers 204 and server computers 206. As used herein, the term forwarding device refers to a network device that receives network communications and routes or forwards those network communications to other network devices. Examples of a forwarding device include a switch, a router, a hub or any other suitable forwarding device. When the protocol used by one of client computers 204 to communicate with one of server computers 206 is a security protocol in which the network communications are encrypted, forwarding device 202 may perform security-related processing, such as cryptographic protection, for server computers 206, rather than have server computers 206 perform the security-related processing themselves. Any suitable cryptographic protection may be performed by forwarding device 202, including encryption/decryption, integrity protection, and integrity verification, as the invention is not limited in this respect. Thus, cryptographically protecting a packet may involve encrypting the packet and/or integrity protecting the packet, while cryptographically unprotecting the packet may involve decrypting and/or integrity-verifying the packet.

In the example of FIG. 2, forwarding device 202 may act as a first point of entry to network 203, so that all network communications to server computers 206 pass through the forwarding device 202. In this respect, it should be appreciated that forwarding device 202, in some embodiments may comprise multiple separate devices. For example, forwarding device 202 may comprise multiple forwarding devices configured as a cohesive system, such as for load balancing or redundancy purposes. As such, the forwarding device 202 may implement other security-related policies, such as firewall policies or access control policies. For example, the forwarding device 202 may determine based on policies configured for network 203, whether a particular type of network communication, such as a network communication to a particular application or over a particular port should be allowed between a computer outside network 203 (e.g., one of client computers 204), and a computer inside network 203 (e.g., one of server computers 206).

Gateway server 208 in network 203 may operate in conjunction with forwarding device 202 to perform security-related processing. For example, in some embodiments, the switch may not be capable of implementing the network access policies desired for network 203. That is, forwarding device 202 may maintain an access control table that indicates whether a particular network communication (e.g., a packet) should be forwarded to its destination or blocked based on the destination IP address and destination port of the communication. However, it may be desired to employ a more complex network access policy in which communications may be allowed or disallowed into network 203 based on other criteria, such as the identity of the user that issued the communication, the time at which the communication was issued or received, or other criteria. Thus, in some embodiments, gateway server 208 may implement some or all of the network policy, and may indicate to forwarding device 202 which communications are allowed and which are to be blocked. As another example, client computers 204 and server computers 206 may employ non-standard extensions to a security protocol that are not supported by the forwarding device. Thus, in some embodiments, gateway server 208 may perform the portion of the security-related processing that relates to the non-standard protocol extensions. Gateway server 208 may be any suitable server computer according to any suitable computer architecture, loaded with any suitable operating system. For example, in some embodiments, gateway server 208 may execute the Windows® Server 2008 operating system.

Gateway server 208 and forwarding device 202 may be assembled and distributed in any suitable way. For example, in some embodiments, gateway server 208 and forwarding device 202 may be packaged together at a manufacturing facility in a single enclosure, such as, for example, an enclosure suitable for rack-mounting. In other examples, gateway server 208 and forwarding device 202 may be assembled and distributed in separate enclosures, and may be capable of operating independently from one another.

In some embodiments, the processing jointly performed by forwarding device 202 and gateway server 208 on behalf of server computers 206 may be opaque to client computers 204. That is, the client computer that sent a communication to one of the server computers may be unaware of the processing performed by forwarding device 202 and gateway server 208.

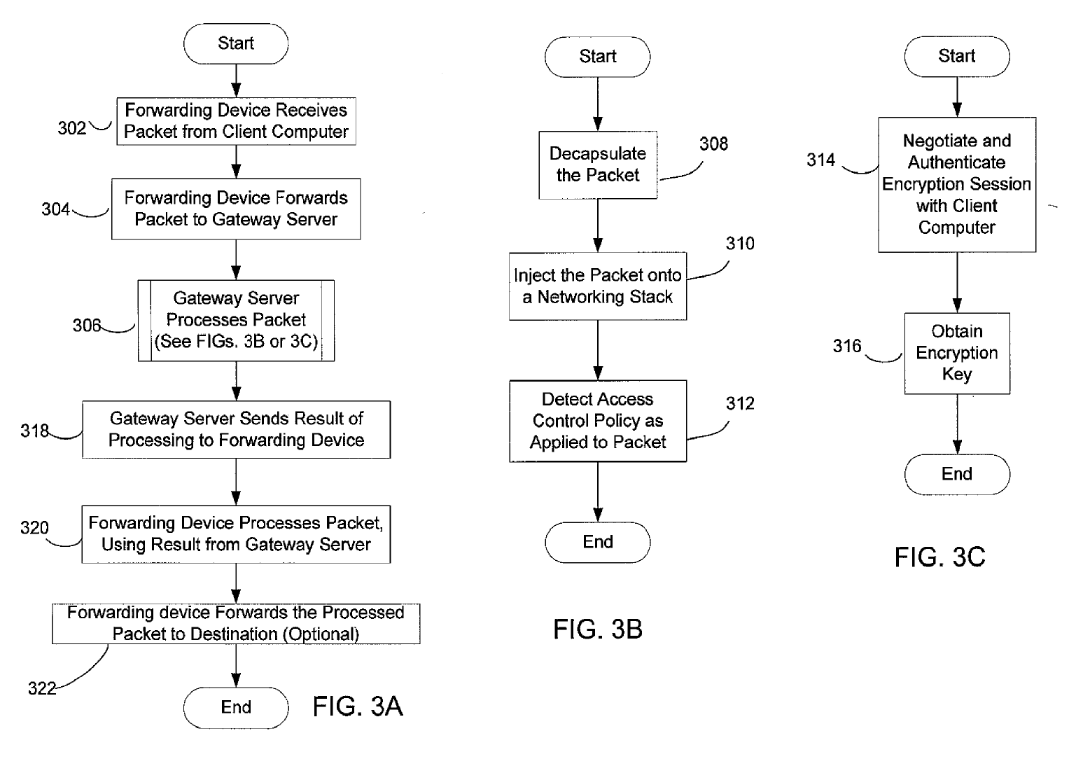

FIG. 3A is a high-level flowchart of a process by which forwarding device 202 and gateway server 208 may jointly process network packets received by the forwarding device 202. The process begins at block 302 with the receipt of a network packet from a client computer at forwarding device 202.

The process continues to block 304, where forwarding device 202 may forward the received packet to gateway server 208 for processing. The packet may be forwarded to gateway server 208 over any suitable network communications medium, including wired or wireless communications media. In some embodiments of the invention, forwarding device 202 may forward the packet to gateway server 208 after it has determined that the forwarding device 202 cannot process the packet on its own, and other received packets may be processed entirely by the forwarding device 202. For example, gateway server 208 may be used to establish a secure connection or to recognize which policies should apply to packets sent over a connection, while subsequent processing for the connection, such as encryption or decryption of data sent over the established connection, may be performed by forwarding device 202.

The process continues to block 306, in which gateway server 208 may, at least partially, process the packet that was forwarded to it by the forwarding device 202. Many types of processing may be performed by gateway server 208, including the processing illustrated in FIG. 3B or 3C, discussed at greater length below.

After at least partially processing the packet, the process then continues to block 318 where gateway server 208 may communicate the result of processing the packet to forwarding device 202. This may be done in any suitable way, as the invention is not limited in this respect. For example, in some embodiments, the result may be communicated over the same communications link that was used in block 304. The result of the processing may be communicated to forwarding device 202 in a format that can be understood by the forwarding device 202.

The process then continues to block 320, where the forwarding device may perform any additional processing of the packet based on the result it received from the processing performed by gateway server 208. This additional processing may include, for example, encrypting or decrypting the packet based on information received from gateway server 208. In some cases, depending on the type of packet, no additional processing of the packet need be performed at block 320.

The process then continues to block 322, where if appropriate, the forwarding device may forward the processed packet to the destination, which in the example discussed above, may be one of server computers 206. In some cases, based on the result of the combined processing performed by the forwarding device 202 and gateway server 208, the forwarding device may determine at this point that, rather than forwarding the packet to the destination, the packet should instead be blocked, according to policies configured for network 203. After block 322, the process ends.

Returning to FIG. 2, the policies for network 203 may be administered and distributed in any suitable way, as the invention is not limited in this respect. In the example of FIG. 2, the policies for network 203 may be created and/or administered on a domain server in network 203, such as domain server 210. The domain server, which may be any suitable domain server, such as an Active Directory™ service included in variants of the Windows® 2008 Server operating system, may propagate the policies to other computers in network 203. The policies propagated by the domain server 210, however, may be too sophisticated for, or in a format that cannot be understood by, the forwarding device 202. In those cases, gateway server 208 may aid in interpreting and applying such policies.

FIG. 3B is a flowchart of a process, according to some embodiments by which gateway server 208 may process (e.g., at block 306 of FIG. 3A) a packet forwarded by forwarding device 202 to recognize (i.e., determine) which policies apply to the packet. The policies may be policies that are distributed by the domain server 210 to computers in network 203, including gateway server 208, but that are too complex, or otherwise not in a format that can be understood and processed by the forwarding device 202.

In some embodiments of the invention, the forwarding device may encapsulate the original packet it received into another network packet when it forwards the packet to gateway server 208. Thus, the process of FIG. 3B begins at block 308, where gateway server 208 may decapsulate the forwarded packet, producing a decapsulated packet that may correspond to the original packet received by forwarding device 202.

Gateway server 208 may then recognize which policies apply to the decapsulated packet in any suitable way. For example, as shown in FIG. 3B, the process may continue to block 310, where gateway server 208 may inject the decapsulated packet onto its networking stack. It may do this in any suitable way, as the invention is not limited in this respect. The process then continues to block 312, where gateway server 208 may recognize which policies may apply to the packet. This may be done in any suitable way. For example, in some embodiments, gateway server 208 may include a policy detector component 212 that determines the network policies to be applied to a packet by a networking stack.

In embodiments in which the processing performed by block 306 corresponds to the processing performed in FIG. 3B, the processing performed at block 318 may involve sending information to the forwarding device 202 describing at least one access control policy recognized in block 312 in a format suitable for the forwarding device 202. In some embodiments, the information sent to forwarding device 202 may also include the original packet itself, or other information sufficient to identify the packet.

Besides the detection of policies, gateway server 208 may also perform other types of processing not supported by forwarding device 202. For example, the packets may be sent according to a security protocol that requires preliminary steps to be performed in establishing a secure connection before two computers can exchange data according to the protocol. For example, the security protocol may require mutual authentication of the two communicating computers, and it may additionally or alternatively require the two computers to negotiate an encryption technique that they will use for subsequent communication. While forwarding device 202 may be capable of performing this negotiation for standard protocols, users of the client computers 204 establishing a secure connection may desire to employ features or extensions to the security protocol, such as authentication techniques, that are not part of the standard and that are not supported by the forwarding device 202.

Accordingly, in some embodiments of the invention, forwarding device 202 may forward packets requiring non-standard processing to gateway server 208. FIG. 3C is a flowchart of a method, according to some embodiments of the invention, of processing in gateway server 208 a packet forwarded by the forwarding device 202, in which gateway server 208 may process the packet according to extensions to the security protocol that are not supported by forwarding device 202. In the example of FIG. 3C, the extensions relate to other types of authentication and session negotiation than are supported by the forwarding device 202. Thus, the process of FIG. 3C is another example of the processing that may be performed by gateway server 208 by block 306 of FIG. 3A.

The process of FIG. 3C may begin at block 314 after the receipt of a forwarded packet from forwarding device 202. At block 314, gateway server 208 may process the packet according to the non-standard extensions, which may involve establishing a secure connection with the sender of the packet. For example, if the packet was issued by one of clients 204, gateway server 208 may initiate a communication session with the one of clients 204 that issued the communication. Establishing the secure connection may involve using non-standard authentication techniques or negotiating parameters (e.g., encryption techniques, integrity protection techniques, or cryptographic keys) to be used for the secure connection. This act may be performed in any suitable way, including, as in the example of FIG. 2, by a negotiation processor 214 in gateway server 208.

The process then continues to act 316 where gateway server 208 may obtain at least one cryptographic key as a result of the processing performed in block 314. When the processing performed by block 306 corresponds to the process illustrated in FIG. 3C, the processing performed at block 318 may correspond to sending the cryptographic key obtained at block 316 to forwarding device 202. The forwarding device 202 may then be able to perform encryption/decryption or integrity protection for packets sent over the connection established by the method of FIG. 3C on its own, without requiring additional processing by gateway server 208.

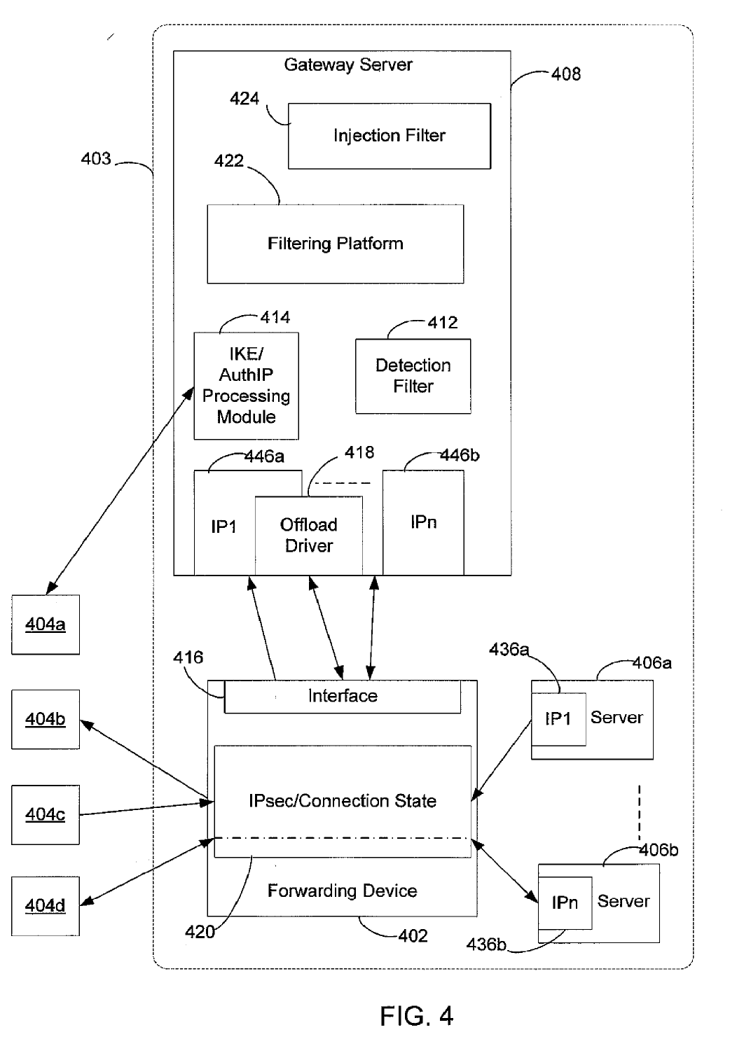

FIG. 4 is a more detailed diagram of a computer system for processing traffic sent according to the IPsec protocol, according to some embodiments of the invention. While the example of FIG. 4 focuses on IPsec, a similar computer system could be employed to process other types of security protocols, such as TLS, SSL, or other protocols that employ encryption, as the invention is not limited in this respect.

The computer system in the example of FIG. 4 includes a forwarding device 402 coupled over a communications link with a gateway server 408, which may be implemented similarly as the forwarding device 202 and gateway server 208, respectively, of FIG. 2. The computer system of FIG. 4 also includes one or more client computers 404a, 404b, 404c and 404d, and one or more server computers 406a and 406b. In the example of FIG. 4, at least some of the communication between client computers 404 and server computers 406 may be encrypted according to the IPsec protocol.

A computer network 403 includes forwarding device 402, server computers 406, and the gateway computer 408. As with the example of FIG. 2, the forwarding device 402 may act as the first point of entry to network 403. In the example of FIG. 4, network communication between client computers 404 and server computers 406 may pass through the forwarding device 402. In conjunction with gateway server 408, forwarding device 402 may apply network policies to network traffic passing through it. These network policies may specify, for example, which network communications should be allowed, which of the allowed communication should be cryptographically protected (e.g., encrypted and/or integrity protected) according to the IPsec protocol, and/or any other suitable information. When the network communication is according to the IPsec protocol, forwarding device 402, in conjunction with gateway server 408, may process the IPsec traffic, thus reducing the processing burden on other computers, such as server computers 406. In the example of FIG. 4, all the communication between server computers 406 and forwarding device 402 is unprotected, as all the encryption/decryption and/or integrity protection that would ordinarily have been performed by each of server computers 406 may be performed by forwarding device 402 in conjunction with gateway server 408. The IPsec processing performed by forwarding device 402 and gateway server 408 may include establishing an IPsec session (called a “security association”, or “SA”) between two computers, as well as the encryption and decryption of IPsec network packets.

As is known in the art, an IPsec SA may be established in either “tunnel mode” or “transport mode.” The illustrative embodiments discussed herein may operate in either tunnel mode or transport mode, as the invention is not limited in this respect. Transport mode is the default mode of establishing an IPsec SA between a first computer and second computer. In transport mode, the SA is established end-to-end, starting at a first computer, and terminating at the second computer. Tunnel mode is another mode of establishing an IPsec SA between a first computer and a second computer in which the first computer explicitly connects to a tunneling device in order to reach the second computer. Accordingly, in tunnel mode, the IPsec SA starts at the first computer, and terminates at the tunneling device.

In the illustrative embodiment of FIG. 4, for example, if an SA is established in tunnel mode between one of client computers 404 and forwarding device 402, it may be apparent to the client computer that the SA terminates at the forwarding device, but that the traffic is forwarded from forwarding device 402 to one of server computers 406. On the other hand, if the SA is established in transport mode between the same two computers (one of client computers 404 and forwarding device 402), then it may appear to the client computer that forwarding device 402 is the end destination of the traffic for the SA (i.e., that both the traffic and the SA terminate at forwarding device 402, such that the client may not be aware of the server computer). Accordingly, in environments in which embodiments of the invention operate in transport mode, unlike in tunnel mode, the client computer need not be aware that the connection passes through forwarding device 402 to the server computer.

Even if the SA is established between one of client computers 404 and one of server computers 406 in transport mode, as discussed above, cryptographic protection may actually be performed on behalf of the server computer by the combination of forwarding device 402 and gateway server 408. Thus, while it may appear to the client computer that the cryptographic protection is end-to-end between the server and the client, the traffic between forwarding device 402/gateway server 408 and the server computer may be unprotected with respect to the SA established with the client computer. This may not be of concern if the forwarding device 402/gateway 408 and server computers 406 are in a restricted portion of a network, or if other types of security are implemented for communications between server computers 406 and forwarding device 402/gateway server 408. For example, a second SA, or a TLS/SSL connection may be established for communication between server computers 406 and forwarding device 402/gateway server 408 that may be opaque to client computers 404.

Some embodiments in which the traffic between server computers 406 and forwarding device 402/gateway server 408 is unprotected by the SA may provide some benefits. For example, network infrastructure devices may operate “behind” forwarding device 402/gateway server 408. Because the traffic passing from forwarding device 402/gateway server 408 to the destination server has already been cryptographically unprotected at the forwarding device 402, such network infrastructure devices may perform operations on the traffic. One such network infrastructure device may be a load balancer located behind forwarding device 402/gateway server 408 that may balance incoming traffic among multiple servers, without the need to perform cryptographic protection.

Regardless of the type of SA established between client computers 404 and server computers 406, forwarding device 402 may not be able to support certain types of security-related processing, and may forward network packets requiring such processing to be processed by gateway server 408. Gateway server 408 may then transmit the results of its processing to forwarding device 402, in order to enable forwarding device 402 to use the results to process future network communication. Forwarding device 402 may include an interface 416 for its communication with gateway server 408, which may be any suitable interface, such as, for example, an application programming interface (API) to a network service on forwarding device 402 that maintains a network connection with gateway server 408.

In the example of FIG. 4, gateway server 408 may handle establishing an initial IPsec session between two computers, as well as detecting policies, such as firewall and security policies that apply to a particular communication session. Once an IPsec session has been established, and the policies have been determined, forwarding device 402 may perform the rest of the processing for that connection, including the actual encryption/decryption and/or integrity protection processing of IPsec network communication. This may be done in any suitable way, as the invention is not limited in this respect.

In the example of FIG. 4, while the session establishment and the policy detection performed by gateway server 408 may be processing that forwarding device 402 is not capable of performing, this type of processing may need only to be performed at the beginning of a communication session between two computers, and may therefore not result in an unduly large processing burden on gateway server 408. On the other hand, in some embodiments of the invention, forwarding device 402 may include dedicated hardware for its portion of the security processing, allowing it to more efficiently perform cryptographic protection on network communications, which may be a computationally intensive task, than could be accomplished using gateway server 408 alone. Thus, the division of processing in the example of FIG. 4 takes advantage both of the flexibility of processing provided by gateway server 408, as well as the performance benefit of using the forwarding device 402 to perform the cryptographic protection. However, in other embodiments of the invention, the processing may be divided differently between gateway server 408 and forwarding device 402, as the invention is not limited in this respect.

Establishing an IPsec session between two computers may involve authentication, as well as negotiation of session parameters. The IPsec authentication and negotiation may be performed using the Internet Key Exchange (IKE) protocol, or other extensions that may not be supported by forwarding device 402, such as the AuthIP protocol included in versions of the WINDOWS® operating system developed by the Microsoft® Corporation. A successfully established IPsec session results in creation of a security association (SA), which may include parameters such as the encryption algorithm to be used, cryptographic key, and a security parameter index (SPI). As is known in the art, an SPI identifies the security parameters, which in combination with the IP address, identify the SA implemented with a packet. In embodiments of the invention, such as the example of FIG. 4, in which gateway server 408 performs the authentication and SA establishment at the start of an IPsec session, this type of processing may be performed in any suitable component or components in gateway server 408. In the example of FIG. 4, the authentication and SA establishment is performed in the IKE/AuthIP processing module 414. The IKE/AuthIP processing module may be implemented as a software component executing on a processor in gateway 408, may be implemented using special purpose hardware, or may be implemented in any other suitable way.

Communicating the SA information, such as keys or SPIs, from gateway server 408 to forwarding device 402 may be done in any suitable way, as the invention is not limited in this respect. In some embodiments, a communication link may be created between gateway server 408 and forwarding device 402 over any suitable computer communications medium. In some embodiments, the communication link between gateway server 408 and forwarding device 402 may be a secure connection, using any suitable security techniques, as the invention is not limited in this respect. In the example of FIG. 4, the communication of SA information is performed using an IPsec NIC offload mechanism to the forwarding device 402. That is, some operating systems, such as versions of the Microsoft® WINDOWS® operating system, include the capability to offload the encryption and decryption of network packets to a NIC having appropriate encryption/decryption support. Such NIC offload techniques typically include a way for the operating system to communicate SA state to the NIC. In the example of FIG. 4, gateway server 408 includes an offload driver 418 that uses the operating system interface normally used by drivers to obtain SA state for relay to an offload-supporting NIC. Offload driver 418 may then communicate with forwarding device 402. Thus, in the example of FIG. 4, gateway server 408 may be able to communicate the SA information to forwarding device 402 via offload driver 418. Once it receives the SA information, forwarding device 402 may store it in any suitable format, in any suitable computer memory. In the example of FIG. 4, forwarding device 402 may store SA information in the IPsec/connection state 420.

Besides performing processing related to IPsec session establishment, gateway server 408 may also perform the recognition of policies configured for network 403 as applicable to network communication passing through forwarding device 402, and communicate those policies to forwarding device 402 so that forwarding device 402 can implement them on subsequent network communication. The policies may be administered and distributed throughout network 403 in any suitable way, including by using a server such as the domain server 210 of FIG. 2, as the invention is not limited in this respect. The policies may be defined in any suitable way, as the invention is not limited in this respect. In some embodiments, at least some policies may be specified by group policy objects (GPOs), although other policy implementations are possible. As is known in the art, group policy objects may define policies for versions of the Microsoft® Windows® operating systems.

As discussed above in conjunction with FIG. 2, gateway server 408 may perform policy recognition for forwarding device 402 for any suitable reason. In the example of FIG. 4, the policies configured for network 403 may be too sophisticated or otherwise in an unsuitable format for the forwarding device 402 to interpret and apply directly. For example, forwarding device 402 may include a connection table as part of the IPsec/Connection state 420. The connection table may keep track of known connections that are allowed, and may be in any suitable format. One example of a format that may be used in some embodiments is a 5-tuple. A 5-tuple may include a source IP address, source port number, destination IP address, destination port number, and communication protocol. However, the network access policies for network 403 may use criteria that go beyond what may be specified in a 5-tuple, such as user, work group, time of transmission, or application version. Thus, in the example of FIG. 4, forwarding device 402 may rely on gateway server 408 to recognize the policies applicable to packets received by the forwarding device 402, and to communicate the policy decision back to the forwarding device 402 in a suitable format, such as whether to allow or deny (e.g., forward or block) a communication for a given 5-tuple.

Gateway server 408 may perform the recognition of the policies in any suitable way, as the invention is not limited in this respect. In the example of FIG. 4, gateway server 408 includes a filtering platform 422. Filtering platform 422 may be any suitable filtering framework. In some embodiments, the Windows Filtering Platform (WFP) included in versions of the Microsoft® WINDOWS® operating system, which allows filtering, monitoring, and modifying of TCP/IP network packets, may be used. Gateway server 408 may be configured with a detection filter 412 that interfaces with the filtering platform to monitor the policies applied to a packet in a network stack of gateway server 408. Accordingly, in some embodiments, gateway computer 408 may make use of an injection filter 424 that can inject a network packet onto a networking stack of gateway server 408, so that gateway server 408 can detect policies that would be applied to the packet by the server.

Packets received by forwarding device 402 may be categorized into several logical groups of packets. One such category may be incoming network packets that are received on forwarding device 402 sent by a computer outside network 403, such as, for example, one of client computers 404. Another category may be outgoing network packets that are received on forwarding device 402 sent by a computer inside network 403, such as one of servers 406, destined to a computer outside network 403. Thus, “incoming” and “outgoing” in this context are with respect to network 403. Incoming packets for establishing an IPsec session, also known as control packets, such as IKE or AuthIP packets, may be treated differently, so it is helpful to consider these packets separately.

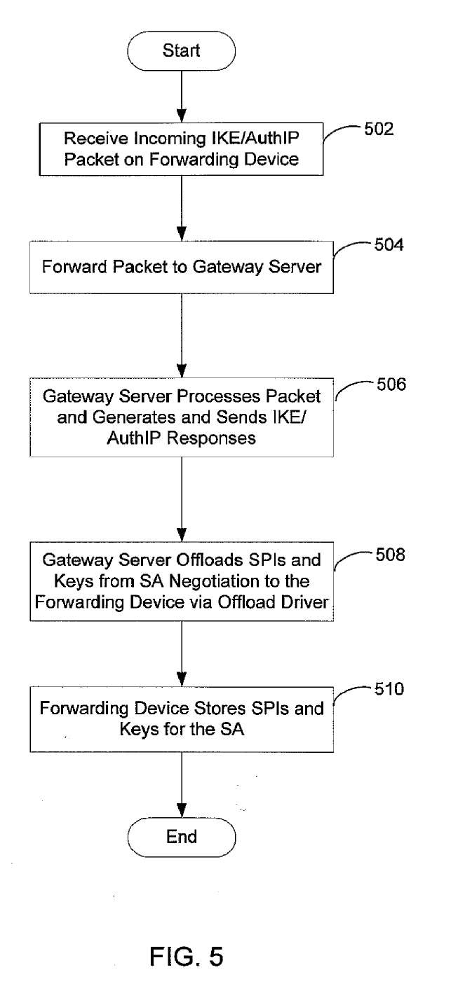

FIG. 5 is a flowchart of a process by which gateway server 408 and forwarding device 402 may jointly process incoming IKE/AuthIP packets received by forwarding device 402. The process begins at block 502, in which forwarding device 402 may receive an incoming IKE/AuthIP packet sent, for example, by one of client computers 404. Upon receiving the packet, forwarding device 402 may inspect the packet and determine whether the packet is an incoming IKE/AuthIP packet in any suitable way.

The process may then continue to block 504, in which forwarding device 402 may forward the packet to gateway server 408. It may forward the packet to gateway server 408 through any suitable interface on forwarding device 402, such as through the interface 416, and through any suitable interface on gateway server 408, as the invention is not limited in this respect. In some embodiments, forwarding device 402 may direct the packet into a standard networking interface on gateway server 408, to be processed as if the packet had been originally directed at the gateway computer 408 itself.

The process may then continue at block 506, in which gateway server 408 may process the packet. It may do so in any suitable way. In the example of FIG. 4, the processing of the IKE/AuthIP packet may be performed by the IKE/AuthIP processing module 414. The processing at block 506 may involve generating and sending IKE/AuthIP responses, negotiating SA information directly with one of client computers 404. In the example of FIG. 4, client computer 404a is illustrated as performing an SA negotiation with gateway server 408.

The process of FIG. 5 may then continue to block 508, in which gateway server 408 may offload SA information obtained in the processing step of block 506 to forwarding device 402. Any suitable SA information, such as SPIs and/or keys, may be offloaded to forwarding device 402. The SA information may be offloaded in any suitable way, including, in the example of FIG. 4, through offload driver 418.

The process illustrated by FIG. 5 may then continue to block 510, in which forwarding device 402 may store the SA information, such as SPIs and/or keys, obtained from gateway server 408 in the processing performed at block 508. The SA information may be stored in any suitable way. In the example illustrated by FIG. 4, the SA information may be stored in the IPsec/connection state 420. After performing the processing at block 510, the process of FIG. 5 ends.

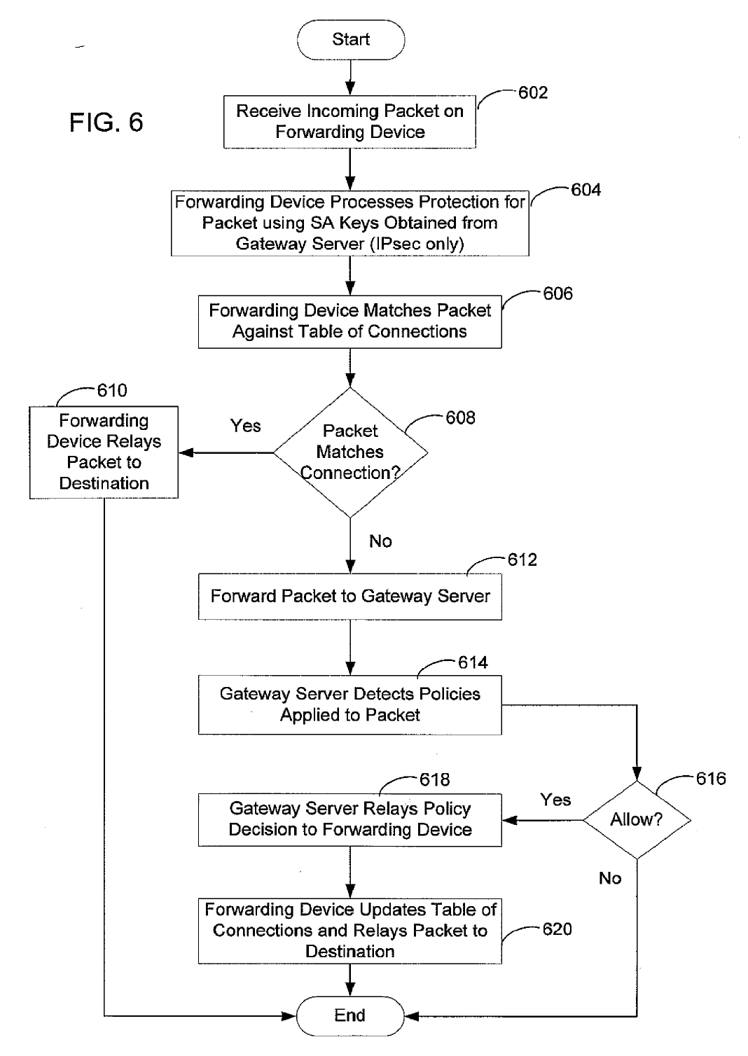

FIG. 6 is a flowchart of a process by which gateway server 408 and forwarding device 402 may jointly process other types of incoming packets besides IKE/AuthIP packets, including both IPsec and non-IPsec (non-secure) packets, received by forwarding device 402. The process of FIG. 6 may begin at block 602, in which forwarding device 402 may receive an incoming packet. Upon receiving the packet, forwarding device 402 may inspect the packet to determine the type of packet. For example, the packet may be inspected to determine whether or not the packet is an IPsec packet.

The process may then continue to block 604, in which, if the packet is an IPsec packet, forwarding device 402 may perform decryption and/or integrity verification for the packet using SA information, such as SA keys and/or SPIs obtained from gateway server 408. The SA information may have been received as a result of the processing of a previous IKE/AuthIP packet corresponding to the same IPsec session, as discussed above in conjunction with the process of FIG. 5. The SA information may have been stored in any suitable way, including in the IPsec/connection state 420 in the example of FIG. 4. It should be appreciated that in some embodiments the processing at block 604 may only be performed for incoming packets that are IPsec packets.

The process may then continue to block 606, where forwarding device 402 may attempt to match the decrypted or integrity-verified packet (or the original incoming packet, if it was not protected using IPsec) against a table of known connections to determine if the network communication should be permitted. The table of known connections may be in any suitable form. In the example of FIG. 4, the table of known connections is part of IPsec/connection state 420, and may be in the 5-tuple format discussed above. If the connection table used by forwarding device 402 is in a format similar to a 5-tuple, there still may not be a connection for this packet even if there is an existing SA created for an IPsec session. This may occur because, while an SA is typically unique for a given IP address and user, a single SA can handle network traffic from multiple ports to multiple ports, and could therefore correspond to multiple 5-tuples. In some embodiments of the invention, including that illustrated by the flowchart of FIG. 6, a connection may only be in the table if it has already been determined to be allowed based on the network policies, and therefore checking if a connection is present in the table is sufficient to determine whether or not the connection is allowed. However, other embodiments may employ different techniques for determining whether or not a connection is allowed based on the connection table, as the invention is not limited in this respect. For example, in some embodiments, the table may also store information about all connections that were attempted, along with an indication of whether or not the connection is allowed, or any other suitable information.

The process may then continue to block 608, where forwarding device 402 may determine whether the packet corresponds to an allowed connection in the connection table, based on the matching performed at block 606. If the connection table indicates that the packet matches a known allowed connection, the process may continue to block 610, in which forwarding device 402 may relay the packet to the destination computer. Thus, in the situation in which the packet matches a known allowable connection in forwarding device 402, the packet may not need to be forwarded at all to gateway server 408, as all the processing, including IPsec processing, may be performed in forwarding device 402 itself. In the example of FIG. 4, this case is illustrated by the dotted line passing straight through forwarding device 402 between client computer 404d and server computer 406b, which may correspond to a known allowable connection in the connection table. After the packet has been relayed to its destination in block 610, the process of FIG. 6 ends.

If, at block 608, the packet does not match an allowable connection in the connection table, the process of FIG. 6 continues to block 612, in which forwarding device 402 may forward the packet to gateway server 408. This may be done in any suitable way, as the invention is not limited in this respect.

In some embodiments of the invention, forwarding device 402 may encapsulate the packet into an encapsulated packet, and direct the encapsulated packet to an injection filter, such as the injection filter 424, on gateway server 408. Injection filter 424 may then decapsulate the encapsulated packet, and inject the decapsulated packet onto a network stack on gateway server 408. However, this is only one example of the way in which a packet that does not match an allowable connection may be forwarded and inserted onto a networking stack on gateway server 408, and the invention is not limited to this particular example.

For example, in other embodiments of the invention, if the original received packet was an IPsec packet, instead of being encapsulated by forwarding device 402, and directed to an injection filter, the decrypted packet may instead be directed to an interface on gateway server 402 for offload driver 418. The offload driver 418 would then propagate the packet up a networking stack on gateway server 408, as if the packet had just been decrypted and/or integrity verified by a NIC with suitable cryptographic protection support, as discussed above in conjunction with FIG. 4. In some embodiments, this may involve setting gateway server 408 in promiscuous mode, so that a networking stack on gateway server 408 may process the packet regardless of a lack of a registered listener on the incoming port.

In other embodiments of the invention, if the original received packet was not an IPsec packet, instead of being encapsulated and directed to an injection filter or instead of being directed to an offload driver, the packet may be directed to a virtual interface on gateway server 408. Turning to the example of FIG. 4, server computers 406a and 406b may each be assigned a unique IP address, such as IP addresses 436a and 436b, respectively. In the embodiment illustrated by FIG. 4, gateway server 408 may include virtual network interfaces 446a and 446b corresponding to each of server computers 406a and 406b, which are assigned the value of the same IP addresses that are assigned to server computers 406 (i.e., IP addresses 436a and 436b, respectively). Accordingly, because gateway server 408 may have a virtual interface with the same IP address for each of server computers 406, gateway server 408 may perform certain processing with the appearance of being any one of server computers 406. Thus, the packet may be directed to the virtual interface on gateway server 408 that corresponds to the IP address of the one of server computers 406 that is the destination computer for the packet. The packet may then be in the networking stack on gateway server 408. As with the embodiment in which the IPsec packet is directed to gateway server 408 through offload driver 418, when gateway server 408 is configured with virtual interfaces, gateway server 408 may be configured so that it is in promiscuous mode. In some embodiments, rate-limiting may be employed in order to avoid overloading gateway server 408 with, for instance, large volumes of non-allowed traffic.

Other embodiments of the invention may allow for forwarding packets between forwarding device 402 and gateway server 408 in other ways. For example, in embodiments of the invention that support establishing an SA in tunnel mode between client computers 404 and server computers 406, gateway computer 408 and forwarding device 402 may be configured to have the same IP address as each other. The same IP address as forwarding device 402 may be configured on gateway server 408 in any suitable way, including by creating a virtual interface on gateway computer 408 with the same IP address as forwarding device 402. Packets may be directed by forwarding device 402 to the interface on gateway server 408 having the same IP address. This type of configuration may be possible because in tunnel mode, the client computer may explicitly connect to the IP address of forwarding device 402. Accordingly, when gateway server 408 receives a packet over the interface having the same IP address as forwarding device 402, gateway server 408 may process the packet as if it had been destined to itself, rather than to forwarding device 402. However, the ability to use this type of configuration in transport mode may be limited, because the client computer may not have explicitly directed any packets to the IP address of forwarding device 402, but may instead have directed packets to an IP address of one of server computers 406. Accordingly, in transport mode, gateway server 408 may have a virtual interface corresponding to an IP address for each of server computers 406, as discussed above.

Regardless of the method of forwarding the packet to gateway server 408, the process then continues at block 614 in which gateway server 408 may detect the policies that are applied to the packet on the networking stack on gateway server 408. This may be done in any suitable way, as the invention is not limited in this respect. In the example of FIG. 4, this may be done by using detection filter 412 that interfaces with filtering platform 422.

The process may then continue to block 616, where it may be determined if the policies indicate that the packet should be allowed. If gateway server 408 determines that the packet is not allowed, then in the embodiment illustrated by FIG. 6, the process of FIG. 6 is finished. On the other hand, if gateway server 408 determines at block 616 that the packet should be allowed, then the process may continue to block 618, in which gateway server 408 may relay the policy decision to forwarding device 402. The process of block 618 may be performed in any suitable way, including by using an API with forwarding device 402 (e.g., interface 416), and according to any suitable format (e.g., a 5-tuple). While in the illustrative embodiment of FIG. 6, the policy decision is only communicated to forwarding device 402 if gateway server 408 determined that the packet should be allowed, it should be appreciated that the invention is not limited in this respect as in other embodiments, gateway server 408 may also communicate the result of the policy decision when the packet should not be allowed.

The process may then continue to block 620, in which forwarding device 402 may update a table of connections to indicate that the connection is known and allowed. This may be done in any suitable way, including, in the embodiment of FIG. 6, by entering a 5-tuple for the connection in the connection table, which may be a portion of IPsec/connection state 420. At block 620, forwarding device 402 may also relay the packet to its destination, which could be, for example, one of server computers 406. Because the connection has been stored and indicated as allowed in the connection table, subsequent network packets received by forwarding device 402 for this connection may be processed entirely by forwarding device 402, without the need for any processing by gateway server 408. After block 620, the process of FIG. 6 ends.

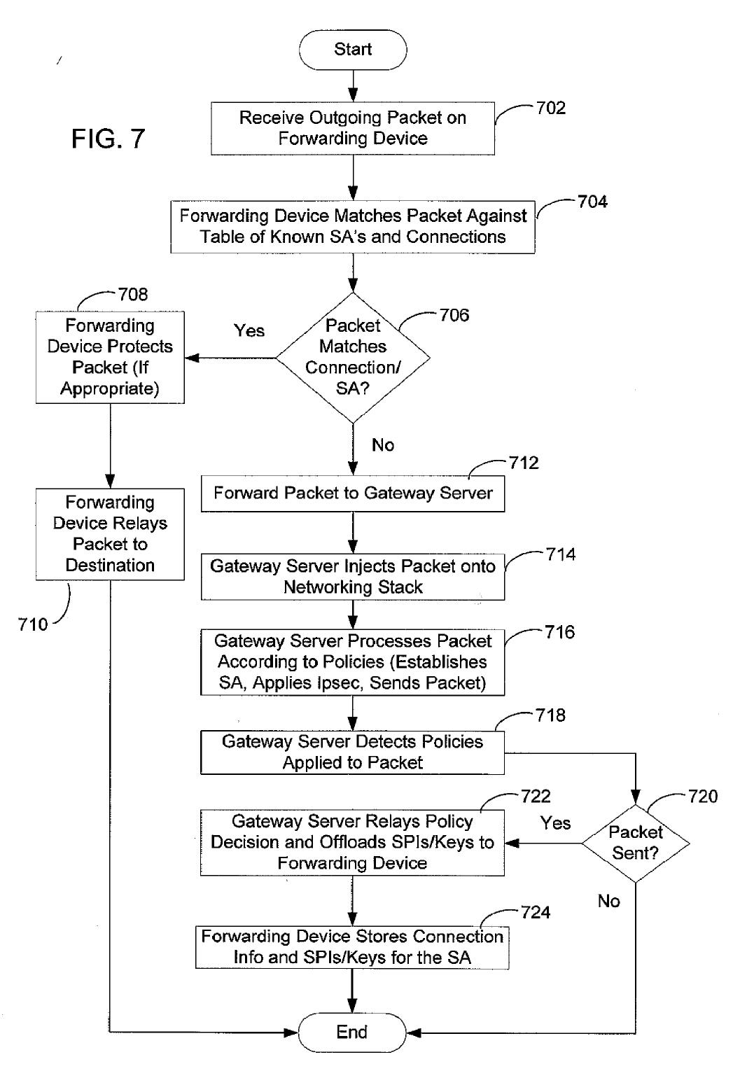

FIG. 7 is a flowchart of a process by which gateway server 408 and forwarding device 402 may jointly process outgoing packets received by forwarding device 402, in some embodiments. The process of FIG. 7 begins at block 702 when forwarding device 402 may receive an outgoing packet. The outgoing packet may have been sent by one of server computers 406, in the example of FIG. 4.

The process then continues to block 704, in which forwarding device 402 may match the packet against one or more tables of known SAs and allowed connections. This may be done in any suitable way, including in the ways discussed above in conjunction with FIG. 6. The process then continues at block 706, in which it is determined if the packet matches any allowed connections or SAs, based on the processing performed at block 704.

If the result of the processing of block 706 indicates that the packet matches a known SA or connection, then the process may continue to block 708, in which forwarding device 402 may cryptographically protect (e.g., encrypt and/or integrity protect) the packet if it is determined to match a known SA. The cryptographic protection may be performed based on stored SA information, such as SPIs and/or keys, obtained from gateway server 408. Regardless of whether the packet is to be protected, the process continues to block 710, in which forwarding device 402 may relay the packet to the destination computer, which may be, for example, one of client computers 404. After performing the processing at block 710, the process of FIG. 7 is finished. Thus, when the packet matches a known SA or connection, in the example of FIG. 7, the processing of the packet may be performed entirely by forwarding device 402, without the need for forwarding the packet for additional processing on gateway server 408. In the example of FIG. 4, the known incoming and outgoing connections are illustrated as being between client computer 404d and server computer 404b, as discussed above in conjunction with FIG. 6.

On the other hand, if the result of the processing at block 706 indicates that the packet did not match a known SA or connection, the process continues to block 712, in which the packet may be forwarded to gateway server 408. The packet may be forwarded to gateway server 408 in any suitable way, including the ways discussed above in conjunction with FIG. 6. In the example of FIG. 7, the packet may be forwarded to gateway server 408 by encapsulating the packet into an encapsulated packet, and sending the encapsulated packet to any suitable interface on gateway server 408, such as a network interface listened on by a service that is capable of decapsulating the encapsulated packet. The process illustrated by FIG. 7 may continue at block 714, in which gateway server 408 may inject the packet onto a networking stack on gateway server 408. This may be done in any suitable way. In the example of FIG. 7, this may be done by having the decapsulating service provide the packet to an injection filter, such as injection filter 424, which may inject the packet onto a networking stack on gateway server 408. However, it should be appreciated that other methods of injecting the packet in a networking stack on gateway server 408 may be employed, as the invention is not limited in this respect. For example, forwarding device 402 may be configured to forward the packet directly to injection filter 424, rather than through some other service on gateway server 408.

Regardless of the method of injecting the packet onto a networking stack in block 714, the process may then continue to block 716, where gateway server 408 may process the packet in its networking stack according to network policies. Firewall policies defined for outgoing traffic may indicate whether the packet is to be allowed or blocked. If the packet is allowed, policies may also indicate that the packet is to be sent encapsulated by IPsec, in which case the processing at block 716 may involve establishing an SA with one of client computers 404 on behalf of one of server computers 406. This may be done in any suitable way, including the ways discussed above in conjunction with the process of FIG. 5. In the example of FIG. 4, establishing an SA may be performed by IKE/AuthIP processing module 414 on gateway server 408. The processing at block 716 may also possibly involve cryptographically protecting the packet, which may be done using SA information, such as keys and/or SPIs, obtained during the SA establishment. As a result of the processing of block 716, gateway server 408 may at this point send the packet, which may be cryptographically protected at this point, to the destination computer, which may be one of client computers 404.

The process of FIG. 7 may then continue to block 718, where gateway server 408 may detect the policies applied to the packet, as it was processed in block 716. This may be done in any suitable way, as the invention is not limited in this respect. In the example of FIG. 4, the policies may be detected using a detection filter 412 that interfaces with a filtering platform 422.

The process of FIG. 7 may then continue to block 720, where gateway server 408 may check if the packet ended up being sent to the destination computer. If the packet is not sent, this indicates that a network policy was configured to block the packet, and the process of FIG. 7 ends. If, on the other hand, the packet is sent to the destination computer, the process may continue to block 722, where gateway server 408 may relay the policy decision and offload any SA information to forwarding device 402. This may be done in any suitable way. In the example of FIG. 7, the policy decision may be communicated to forwarding device 402 through an interface, such as interface 416 to indicate to forwarding device 402 whether the packet should be allowed, and if so, if IPsec should be applied to it. While the SA information may be communicated to forwarding device 402 in any suitable way, in the example of FIG. 7, the SA information, such as SPIs and/or keys may be offloaded to forwarding device 402 using the offload driver 418 of FIG. 4, as discussed above in conjunction with FIGS. 5 and 6. The policies may also include information regarding whether or not the packet is to be cryptographically protected, and the type(s) of protection to be applied (e.g., encryption, integrity-protection, etc.). While in the example of FIG. 7, policies are not communicated to forwarding device 402 when the packet is to be blocked, in other embodiments, gateway server 408 may relay the policy decision to forwarding device 402 in either case, including when the packet was blocked. Doing so may avoid repeated relays to gateway server 408 when one of server computers 406 repeatedly generates packets that should be blocked.

The process may then continue to block 724 where forwarding device 402 may, based on the result of the processing performed by gateway server 408, store information regarding the connection and SA information, such as SPIs and/or keys, for future use. The storing may be done in any suitable way, and in any suitable format, as the invention is not limited in this respect. In the example of FIG. 4, the connection information and SA information may be stored in the IPsec/connection state 420, so that subsequent packets sent according to the same SA or connection that are received by forwarding device 402 may be able to be processed entirely by gateway server 408 without any additional processing by forwarding device 402. After the processing of block 724, the method of FIG. 7 ends.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

For example, it is to be appreciated that the IPsec processing performed jointly by forwarding device 402 and gateway server 408 may include processing any suitable type of cryptographic protection. Encryption/decryption of network packets is only one example of various types of cryptographic protection that may be processed. For example, the joint processing performed by forwarding device 402 and gateway server 408 may also verify the integrity of network packets sent according to the IPsec protocol. Thus, in general, a packet that requires cryptographic protection (e.g., an encrypted or integrity-protected packet) may be termed a “cryptographically protected packet,” while a packet not subject to such cryptographic protection may be termed an “unprotected packet.” Security policies detected by gateway server 408 and communicated to forwarding device 402 may include general cryptographic protection policies that indicate, for example, whether a network packet should be encrypted and/or integrity protected before being forwarded to its destination.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

It should be appreciated that any hardware component or collection of hardware components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of processing encryption data in a computer system comprising a first computer that communicates with at least one second computer via a packet forwarding device coupled to a third computer, the method comprising:
receiving, at the packet forwarding device, a first packet sent from the first computer to the at least one second computer, wherein the first computer does not designate the third computer as a recipient of the first packet;
determining whether the first packet comprises a control packet for configuring an encrypted connection between the first computer and the at least one second computer;
when it is determined that the first packet comprises a control packet:
sending the control packet to the third computer; and
in response to sending the control packet to the third computer, receiving from the third computer at least one cryptographic key; and
when it is determined that the first packet comprises at least one cryptographically protected data packet:
cryptographically unprotecting the at least one cryptographically protected data packet using the at least one cryptographic key.

2. The method of claim 1, wherein the first packet is sent according to either the TLS protocol or the SSL protocol.

3. The method of claim 1, wherein the first packet is sent according to the IPsec protocol.

4. The method of claim 3, wherein the control packet comprises a packet sent according to a negotiation protocol, and wherein the negotiation protocol comprises at least one of the Internet Key Exchange (IKE) protocol or the AuthIP protocol.

5. The method of claim 4, wherein the method further comprises an act of establishing on the third computer a Security Association (SA) operating in transport mode negotiated according to the negotiation protocol between the first computer and the third computer.

6. The method of claim 5, wherein the act of receiving from the third computer at least one cryptographic key further comprises an act of receiving from the third computer at least one cryptographic key and at least one Security Parameter Index (SPI), wherein the at least one cryptographic key and the at least one SPI are associated with the SA negotiated between the first computer and the third computer, and wherein the method further comprises storing in computer memory on the forwarding device the at least one cryptographic key and the at least one SPI.

7. The method of claim 6, wherein the at least one cryptographic key and the at least one SPI are received over a NIC offload interface on the third computer.

8. The method of claim 7, wherein that act of determining that the first packet comprises at least one cryptographically protected data packet comprises determining that the first packet comprises at least one cryptographically protected data packet associated with the at least one cryptographic key and the at least one SPI.

9. At least one computer-readable medium encoded with instructions that, when executed on a computer system, perform a method of processing encryption data, wherein the computer system comprises a first computer that communicates with at least one second computer via a packet forwarding device, the computer system further comprising a third computer connected to the packet forwarding device, the method comprising:
receiving, at the third computer, an encapsulated packet from the packet forwarding device;
decapsulating the encapsulated packet to generate a decapsulated packet;
injecting the decapsulated packet onto a networking stack on the third computer;
detecting at least one access control policy applied to the decapsulated packet by the third computer; and
sending information describing the at least one access control policy to the packet forwarding device.

10. The at least one computer-readable medium of claim 9, wherein the decapsulated packet comprises a packet that was sent from the first computer to the at least one second computer.

11. The at least one computer-readable medium of claim 10, wherein the at least one access control policy comprises at least one firewall policy indicating whether the decapsulated packet should be forwarded to the at least one second computer.

12. The at least one computer-readable medium of claim 10, wherein the at least one access control policy comprises at least one cryptographic protection policy indicating whether the decapsulated packet should be cryptographically protected before being forwarded to the at least one second computer.

13. The at least one computer-readable medium of claim 10, wherein the at least one access control policy is specified by a group policy object.

14. The at least one computer-readable medium of claim 10, wherein detecting at least one access control policy applied to the decapsulated packet by the third computer is performed using a detection filter operating via a filtering platform.

15. The at least one computer-readable medium of claim 10, wherein the act of injecting the decapsulated packet onto a networking stack on third computer is performed by an injection filter operating via a filtering platform.

16. A packet forwarding device for use in a computer system comprising the packet forwarding device, a first computer that communicates with at least one second computer via the packet forwarding device, and a third computer coupled to the packet forwarding device, the packet forwarding device comprising:
a communication interface; and
at least one controller that:
receives, via the communication interface, a first packet sent from the first computer to the at least one second computer;
determines by consulting information stored in a memory of the packet forwarding device whether the first packet is associated with a connection between the first computer and the at least one second computer that is permitted according to at least one access control policy;
when it is determined that the first packet is associated with a connection between the first computer and the at least one second computer that is permitted according to at least one access control policy:
sends the first packet to the at least one second computer; and
when it is determined that the first packet is not associated with a connection between the first computer and the at least one second computer that is permitted according to at least one access control policy:
sends the first packet to the third computer;
in response to sending the first packet to the third computer, receives information describing at least one access control policy indicating whether the first packet may be sent to the at least one second computer; and
updates the information stored in the memory of the packet forwarding device with the information describing the at least one access control policy for a connection between the first computer and the at least one second computer.

17. The packet forwarding device of claim 16, wherein:
the information describing the at least one access control policy comprises at least one cryptographic key; and
prior to sending the first packet to the at least one second computer, the at least one controller:
determines by consulting the information stored in the memory whether the first packet is to be encrypted and/or cryptographically integrity-protected;
and
when it is determined that the first packet is to be encrypted and/or integrity-protected, encrypts and/or integrity-protects the first packet to generate a protected packet using the at least one cryptographic key.

18. The packet forwarding device of claim 16, wherein the at least one controller sends the first packet to a NIC offload interface on the third computer.

19. The packet forwarding device of claim 16, wherein the at least one controller encapsulates the first packet to generate an encapsulated packet, and sends the encapsulated packet to the third computer.

20. The packet forwarding device of claim 16, wherein the first packet is formatted according to the IPsec protocol.
